(19) United States
(12) Patent Application Publication
(10) Pub. No.: US 2018/0375807 A1
(43) Pub. Date: Dec. 27, 2018

(54) VIRTUAL ASSISTANT SYSTEM ENHANCEMENT

(71) Applicant: KONINKLIJKE PHILIPS N.V., Eindhoven (NL)

(72) Inventors: JAN MARTIJN KRANS, DEN BOSCH (NL); JOYCA PETRA WILMA, EINDHOVEN (NL); ARLETTE VAN WISSEN, CULEMBORG (NL); JAN TATOUSEK, EINDHOVEN (NL); ANNERIEKE HEUVELINK-MARCK, EINDHOVEN (NL)

(21) Appl. No.: 16/015,394

(22) Filed: Jun. 22, 2018

Related U.S. Application Data
(60) Provisional application No. 62/523,823, filed on Jun. 23, 2017.

(51) Int. Cl. H04L 12/58

(52) U.S. Cl. CPC H04L 51/046; H04L 51/10; H04L 51/18

(57) ABSTRACT

In one embodiment, a computer-implemented method comprising receiving an electronic message, the electronic message comprising a first motivational message; determining any one or a combination of a coaching style or content personalized to a user based on an analysis of the first motivational message; and setting any one or a combination of the coaching style or content for future electronic messages directed to the user based on a confidence of the determination meeting a threshold confidence level.

### CROSS-REFERENCE TO RELATED APPLICATIONS

This patent application claims the priority benefit under 35 U.S.C. § 119(e) of U.S. Provisional Application No. 62/523,823 filed on Jun. 23, 2017, the contents of which is herein incorporated by reference.

### FIELD OF THE INVENTION

The present invention is generally related to digital devices and systems that facilitate user interactions with virtual assistants.

### BACKGROUND OF THE INVENTION

Users are increasingly relying on various systems and devices to assist them in activities. For instance, with the ubiquity and computational power of smart phones, a traveler can use the browser application of his or her smart phone while on the road to type in (or audibly query) travel routes, traffic conditions, and/or areas of interest (of course, while a passenger or pulled off the side of the road for safety). Likewise, sports fans that are missing their favorite game due to other obligations can pull up the latest score (or listen to it on their phone) in practically any venue. Outdoor enthusiasts can keep apprised of up-to-date weather patterns and/or the latest news through brief queries on their phone as well.

An added layer of sophistication takes the form of improved interactivity between the device and the user and electronic messaging. For instance, voice recognition has permeated appliances ranging from the smart phone, to laptops, to automobile navigation systems, among other devices. Virtual digital assistants, which comprise automated software that receive both written and voice-activated commands and provide written or audible messaging (e.g., feedback, instructions, etc.) have become increasingly popular of late. Well-known virtual assistants include Siri® from Apple®, Cortana® from Microsoft®, Google® Assistant from Alphabet, and Alexa® from Amazon®. Appliances equipped with such software, which can include smart phones, activity trackers, automobiles, kitchen appliances, etc., can even advance a step beyond mere feedback and suggest and then actually order pizza for you, call an Uber®, or advise of the latest sports scores or news. As helpful as virtual assistants are, they still are perceived as robotic in expression and predictable in their messaging, lacking in user-specificity or tailored profile.

### SUMMARY OF THE INVENTION

In one embodiment, a computer-implemented method comprising receiving an electronic message, the electronic message comprising a first motivational message; determining any one or a combination of a coaching style or content personalized to a user based on an analysis of the first motivational message; and setting any one or a combination of the coaching style or content for future electronic messages directed to the user based on a confidence of the determination meeting a threshold confidence level.

These and other aspects of the invention will be apparent from and elucidated with reference to the embodiment(s) described hereinafter.

### BRIEF DESCRIPTION OF THE DRAWINGS

Many aspects of the invention can be better understood with reference to the following drawings, which are diagrammatic. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram that illustrates an example environment in which a rapport building virtual assistant system is used, in accordance with an embodiment of the invention.

FIG. 2 is a schematic diagram that illustrates an example wearable device in which all or a portion of the functionality of a rapport building virtual assistant system may be implemented, in accordance with an embodiment of the invention.

FIG. 3 is a schematic diagram that illustrates an example electronics device in which all or a portion of the functionality of a rapport building virtual assistant system may be implemented, in accordance with an embodiment of the invention.

FIG. 4 is a schematic diagram that illustrates an example computing device in which at least a portion of the functionality of a rapport building virtual assistant system may be implemented, in accordance with an embodiment of the invention.

FIG. 5 is a flow diagram that illustrates an example process implemented by a rapport building virtual assistant system, in accordance with an embodiment of the invention.

FIGS. 6A-6B are schematic diagram that illustrate example user interfaces used by a rapport building virtual assistant system, in accordance with an embodiment of the invention.

FIG. 7 is a flow diagram that illustrates an example rapport building virtual assistant method, in accordance with an embodiment of the invention.

### DETAILED DESCRIPTION OF EMBODIMENTS

Disclosed herein are certain embodiments of a rapport building virtual assistant system, apparatus, and method (also collectively referred to herein as a rapport building virtual assistant system) that overcome various deficiencies in communication (messaging) present in virtual assistant systems, such as digital coaching systems, by determining a coaching style and/or content personalized to a user, and interacting with the user according to the determined style and/or content. In one embodiment, the rapport building virtual system receives an electronic message comprising a motivational message created by a user for a different user, analyzes the motivational message to determine one or more features associated with a coaching style and/or content personalized to the user, determines a confidence level associated with the determined style and/or content, sets the coaching style and/or content for future electronic messages based on meeting the confidence level, and generates and sends subsequent motivational messages with the one or more features associated with the coaching style and/or content.

Digressing briefly, an expression often heard about good social practice is to treat others the way you want to be treated, which also includes speaking to others the way you would want to be spoken to or spoken of. This suggests that in our society the way people want to be spoken to can be inferred from the way they speak to their contacts, like friends or family members. Related to this, rapport refers to a state of harmonious understanding with another individual or group that enables greater and easier communication. In other words, rapport is a term used for getting along well with another person or a group of people by having things in common, and can be built and developed by finding common ground, developing a bond and being empathic during conversations. For instance, people are generally more receptive to people like themselves, a trait that is built-in to the most primitive parts of the human brain and that can be tapped into in various ways, but especially through subtle mimicry. Examples of subtle ways to build rapport during a conversation are to mirror body language, voice tonality, speech rate, and breathing pattern. In everyday life, building rapport can help with persuasion, sales, teamwork, dating and getting bigger tips. Also in a coach-client relationship, for instance, building rapport can help a human coach to get the most out of interactions with a client user. Concerning building rapport between humans and virtual assistant coaches, research also suggests the potential for virtual assistant characters to establish rapport with humans through simple contingent nonverbal behaviors.

In many virtual assistant systems, including digital health coach programs aimed at behavior change, coaching messages are often delivered to the user via a newsfeed on their smartphone or tablet or wearable app or web portal. Example programs from Philips Personal Health Solutions are General Health and Heart Health. An example program from Philips H2H business is the eCareCompanion. In a human coach-client relationship, rapport can be built during real-time coaching sessions. However, these digital coaching programs do not necessarily include a real-time conversation between a human coach and client. The question now for a digital coaching program, and indeed for other virtual assistant systems, is how to find out what the coaching style, intonation or content is that leads to optimal rapport building with the virtual assistant, thereby raising the persuasive power of the message and increasing the user experience (a stronger feeling of connectedness or personalization with the virtual assistant). Certain embodiments of a rapport building virtual assistant system increase the impact of motivational messages in a virtual digital coaching, training, consulting, and/or educational program by detecting the coaching style and/or content that optimally builds a rapport with the user, and uses this information to send similar (style and/or content) messages to the user.

Having summarized certain features of a rapport building virtual assistant system of the present disclosure, reference will now be made in detail to the description of a rapport building virtual assistant system as illustrated in the drawings. While a rapport building virtual assistant system will be described in connection with these drawings, there is no intent to limit the rapport building virtual assistant system to the embodiment or embodiments disclosed herein. For instance, though described in the context of health and fitness coaching services, certain embodiments of a rapport building virtual system may be used to influence the behavior of a user in other contexts, including the areas of training and instruction, medical treatment, diet adherence, rehabilitation (e.g., physical or mental, including addiction counseling), finance or other business (e.g., wealth management or change management) or personnel management. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents consistent with the disclosure as defined by the appended claims. Further, it should be appreciated in the context of the present disclosure that the claims are not necessarily limited to the particular embodiments set out in the description.

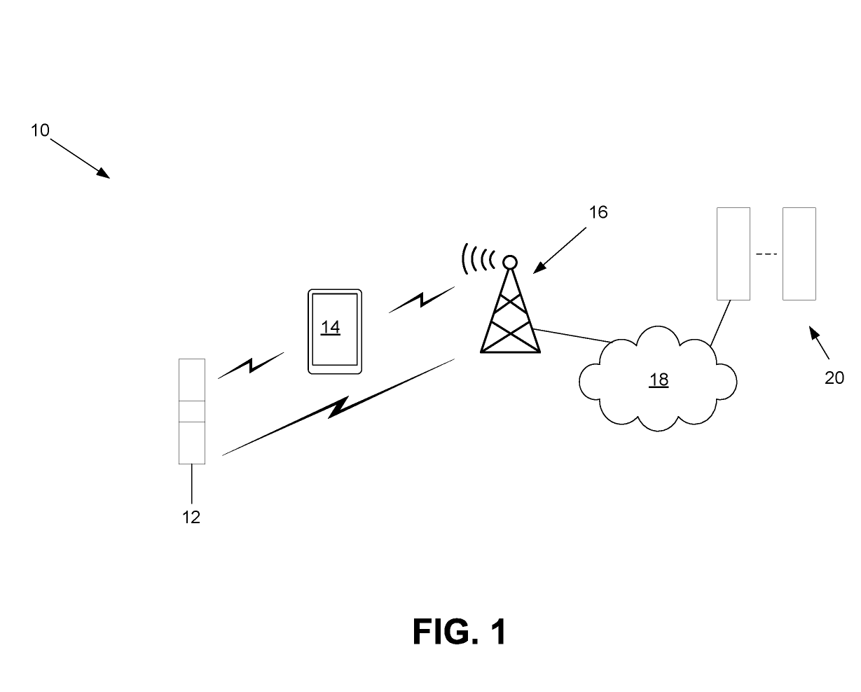

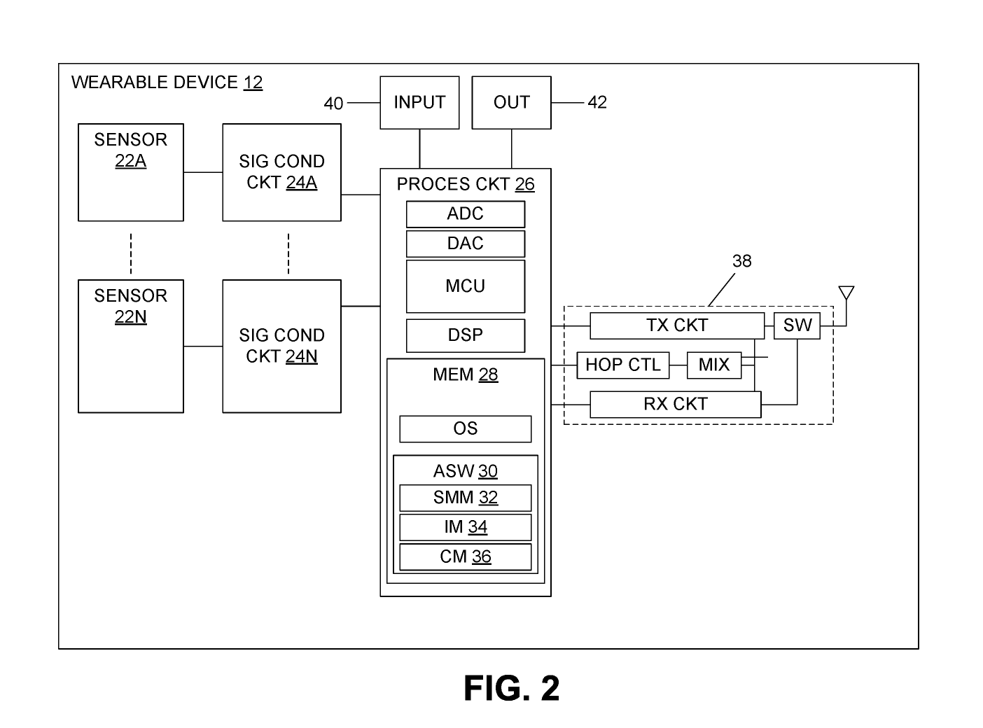

Referring now to FIG. 1, shown is an example environment 10 in which certain embodiments of a rapport building virtual assistant system may be implemented. It should be appreciated by one having ordinary skill in the art in the context of the present disclosure that the environment 10 is one example among many, and that some embodiments of a rapport building virtual assistant system may be used in environments with fewer, greater, and/or different components that those depicted in FIG. 1. The environment 10 comprises a plurality of devices that enable communication of information throughout one or more networks. The depicted environment 10 comprises a wearable device 12, an electronics (e.g., portable) device 14, a cellular network 16, a wide area network 18 (e.g., also described herein as the Internet), and a remote computing system 20 comprising one or more computing devices and/or storage devices. Note that the wearable device 12 and the electronics device 14 are also referred to as user devices. The wearable device 12, as described further in association with FIG. 2, is typically worn by the user (e.g., around the wrist or torso or attached to an article of clothing), and comprises a plurality of sensors that track physical activity of the user (e.g., steps, swim strokes, pedaling strokes, sports activities, etc.), sense/measure or derive physiological parameters (e.g., heart rate, respiration, skin temperature, calories, etc.) based on the sensor data, and optionally sense various other parameters (e.g., outdoor temperature, humidity, location, etc.) pertaining to the surrounding environment of the wearable device 12. For instance, in some embodiments, the wearable device 12 may comprise a global navigation satellite system (GNSS) receiver (and associated positioning software and antenna(s)), including a GPS receiver, which tracks and provides location coordinates (e.g., latitude, longitude, altitude) for the device 12. Other information associated with the recording of coordinates may include speed, accuracy, and a time stamp for each recorded location. In some embodiments, the location information may be in descriptive form, and geofencing (e.g., performed locally or external to the wearable device 12) is used to transform the descriptive information into coordinate numbers. In some embodiments, the wearable device 12 may comprise indoor location technology, including beacons, RFID or other coded light technologies, WiFi, etc. In some embodiments, GNSS functionality may be performed at the electronics device 14 in addition to, or in lieu of, such functionality being performed at the wearable device 12. Some embodiments of the wearable device 12 may include a motion or inertial tracking sensor, including an accelerometer and/or a gyroscope, providing movement data of the user (e.g., to detect limb movement and type of limb movement to facilitate the determination of whether the user is engaged in sports activities, stair walking, or bicycling, or the provision of other contextual data). A representation of such gathered data may be communicated to the user via an integrated display on the wearable device 12 and/or on another device or devices.

Also, such data gathered by the wearable device 12 may be communicated (e.g., continually, periodically, and/or aperiodically, including upon request) to one or more electronics devices, such as the electronics device 14 or to the computing system 20 via the cellular network 16. Such communication may be achieved wirelessly (e.g., using near field communications (NFC) functionality, Blue-tooth functionality, 802.11-based technology, etc.) and/or according to a wired medium (e.g., universal serial bus (USB), etc.). Further discussion of the wearable device 12 is described below in association with FIG. 2.

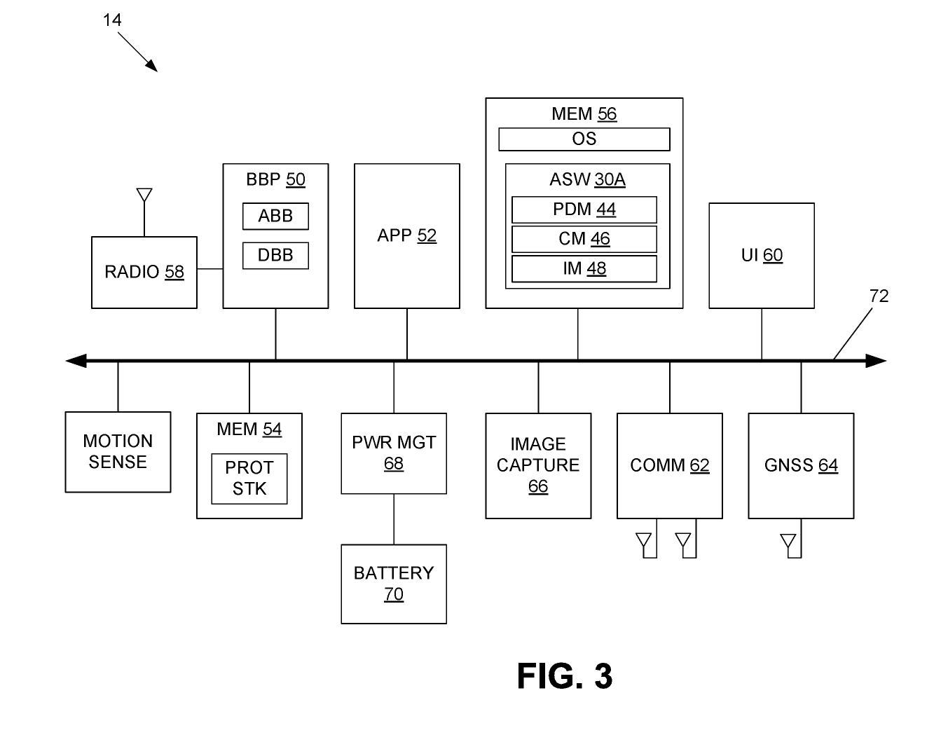

The electronics device 14 may be embodied as a smartphone, mobile phone, cellular phone, pager, stand-alone image capture device (e.g., camera), laptop, workstation, among other handheld and portable computing/communication devices. In some embodiments, the electronics device 14 is not necessarily readily portable or even portable. For instance, the electronics device 14 may be a home appliance, including a refrigerator, microwave, oven, pillbox, home monitor, stand-alone home virtual assistant, one or more of which may be coupled to the computing system 20 via one or more networks (e.g., through the home Internet connection or telephony network), or a vehicle appliance (e.g., the automobile navigation system or communication system). In the depicted embodiment of FIG. 1, the electronics device 14 is a smartphone, though it should be appreciated that the electronics device 14 may take the form of other types of devices including those described above. Further discussion of the electronics device 14 is described below in association with FIG. 3, with smartphone and electronics device 14 used interchangeably hereinafter.

In one embodiment, the wearable device 12 or electronics device 14 individually comprise the full functionality of the rapport building virtual assistant system. In some embodiments, the wearable device 12 and electronics device 14 collectively comprise the full functionality of the rapport building virtual assistant system (e.g., the functionality of the rapport building virtual assistant system is distributed among the two devices). In some embodiments, functionality of the rapport building virtual assistant system is distributed among the wearable device 12 (or electronics device 14) and the computing system 20. In some embodiments, functionality of the rapport building virtual assistant system is distributed among the wearable device 12, the electronics device 14, and the computing system 20. For instance, the wearable device 12 and/or the electronics device 14 may present electronic messages via a user interface and provide sensing functionality, yet rely on remote data structures (e.g., message databases) and/or processing of the remote computing systems 20.

The cellular network 16 may include the necessary infrastructure to enable cellular communications by the electronics device 14 and optionally the wearable device 12. There are a number of different digital cellular technologies suitable for use in the cellular network 16, including: GSM, GPRS, CDMAOne, CDMA2000, Evolution-Data Optimized (EV-DO), EDGE, Universal Mobile Telecommunications System (UMTS), Digital Enhanced Cordless Telecommunications (©ECT), Digital AMPS (IS-136/TDMA), and Integrated Digital Enhanced Network (iDEN), among others.

The wide area network 18 may comprise one or a plurality of networks that in whole or in part comprise the Internet. The electronics device 14 and optionally wearable device 12 access one or more devices of the computing system 20 via the Internet 18, which may be further enabled through access to one or more networks including PSTN (Public Switched Telephone Networks), POTS, Integrated Services Digital Network (ISDN), Ethernet, Fiber, DSL/ADSL, among others.

The computing system 20 comprises one or more devices coupled to the wide area network 18, including one or more computing devices networked together, including an application server(s) and data storage. The computing system 20 may serve as a cloud computing environment (or other server network) for the electronics device 14 and/or wearable device 12, performing processing and data storage on behalf of (or in some embodiments, in addition to) the electronics devices 14 and/or wearable device 12. When embodied as a cloud service or services, the device(s) of the remote computing system 20 may comprise an internal cloud, an external cloud, a private cloud, or a public cloud (e.g., commercial cloud). For instance, a private cloud may be implemented using a variety of cloud systems including, for example, Eucalyptus Systems, VMWare vSphere®, or Microsoft® HyperV. A public cloud may include, for example, Amazon EC2®, Amazon Web Services®, Terremark®, Savvis®, or GoGrid®. Cloud-computing resources provided by these clouds may include, for example, storage resources (e.g., Storage Area Network (SAN), Network File System (NFS), and Amazon S3®), network resources (e.g., firewall, load-balancer, and proxy server), internal private resources, external private resources, secure public resources, infrastructure-as-a-services (IaaSs), platform-as-a-services (PaaSs), or software-as-a-services (SaaSs). The cloud architecture of the devices of the remote computing system 20 may be embodied according to one of a plurality of different configurations. For instance, if configured according to MICROSOFT AZURE™, roles are provided, which are discrete scalable components built with managed code. Worker roles are for generalized development, and may perform background processing for a web role. Web roles provide a web server and listen for and respond to web requests via an HTTP (hypertext transfer protocol) or HTTPS (HTTP secure) endpoint. VM roles are instantiated according to tenant defined configurations (e.g., resources, guest operating system). Operating system and VM updates are managed by the cloud. A web role and a worker role run in a VM role, which is a virtual machine under the control of the tenant. Storage and SQL services are available to be used by the roles. As with other clouds, the hardware and software environment or platform, including scaling, load balancing, etc., are handled by the cloud.

In some embodiments, the devices of the remote computing system 20 may be configured into multiple, logically-grouped servers (run on server devices), referred to as a server farm. The devices of the remote computing system 20 may be geographically dispersed, administered as a single entity, or distributed among a plurality of server farms, executing one or more applications on behalf of one or more of the electronic devices 14 and/or wearable device 12. The devices of the remote computing system 20 within each farm may be heterogeneous. One or more of the devices may operate according to one type of operating system platform (e.g., WINDOWS NT, manufactured by Microsoft Corp. of Redmond, Wash.), while one or more of the other devices may operate according to another type of operating system platform (e.g., Unix or Linux). The group of devices of the remote computing system 20 may be logically grouped as a farm that may be interconnected using a wide-area network (WAN) connection or medium-area network (MAN) connection. The devices of the remote computing system 20 may each be referred to as (and operate according to) a file server device, application server device, web server device, proxy server device, or gateway server device.

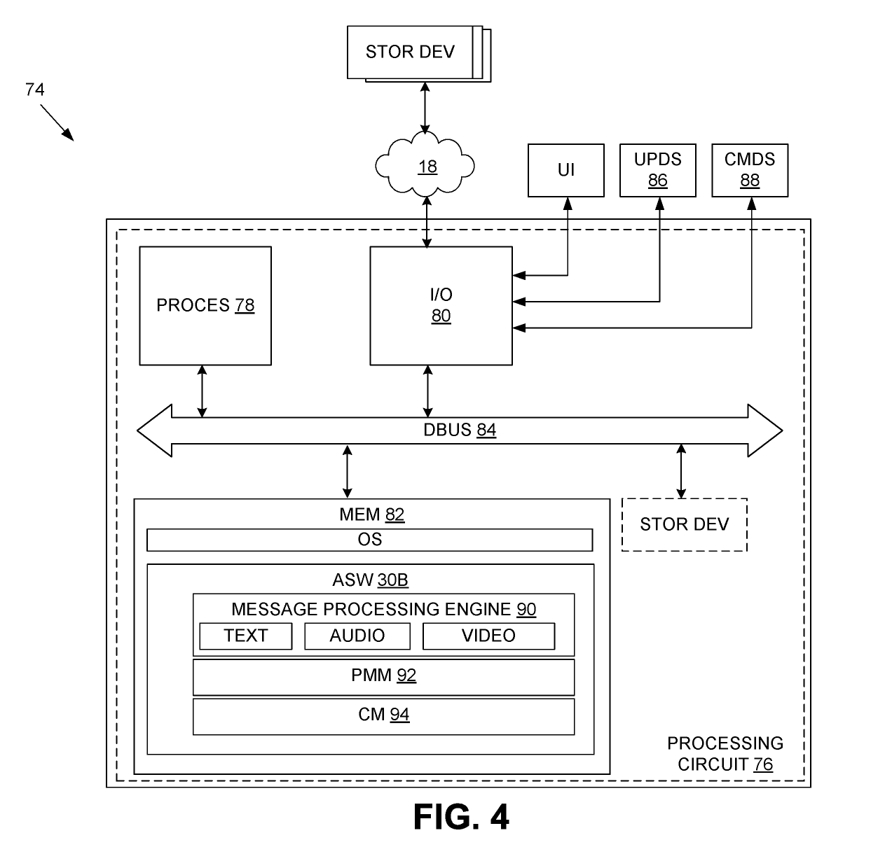

In one embodiment, the computing system 20 may comprise a web server that provides a web site that can be used by users to input a specific motivational message for a friend or family member (and/or in some embodiments, to receive electronic messages with personalized motivational messages), though other platforms may be used to enable user input or the receipt of electronic messages, including functionality that provides push notifications or device-run local applications. The computing system 20 receives data collected via one or more of the wearable device 12 or electronics device 14 and/or other devices or applications (including in some embodiments, the inputted motivational message and selected mechanism for desired delivery of electronic messaging), stores the received data in a user profile data structure (e.g., database) and/or other memory, processes the information to determine appropriate personal behavioral determinants and/or a personality to target and a coaching style and/or content personalized to a user, and delivers electronic messages according to the personalized style and/or content to the electronics device 14 and/or wearable device 12. The computing system 20 is programmed to handle the operations of one or more health or wellness programs implemented also on the wearable device 12 and/or electronics device 14 via the networks 16 and/or 18. For example, the computing system 20 processes user registration requests, user device activation requests, user information updating requests, data uploading requests, data synchronization requests, etc. The data received at the computing system 20 may include a plurality of measurements pertaining to sensed or determined parameters, for example, body movements and activities, heart rate, respiration rate, blood pressure, body temperature, light and visual information, etc. and the corresponding context. Such measurements and/or information derived from the measurements may provide additional information about the motivational message written by the user, including the emotional, physical, or psychological state of the writer, enabling the determination of opportune moments for delivery of the messages and/or facilitating the determination of the appropriate content and/or style of the electronic message. Based on the data observed during a period of time for each user, and further based on analysis (e.g., syntactic and semantic analysis) of the inputted motivational message(s) by the user, the computing system 20 generates user-personalized messaging of a set coaching style and/or content (to optimally establish rapport with the user) for delivery via the networks 16 and/or 18 for presentation on devices 12 and/or 14. In some embodiments, the computing system 20 is configured to be a backend server for a health-related program or a health-related application implemented on the mobile devices. The functions of the computing system 20 described above are for illustrative purpose only. The present disclosure is not intended to be limiting. The computing system 20 may include one or more general computing server devices or dedicated computing server devices. The computing system 20 may be configured to provide backend support for a program developed by a specific manufacturer. However, the computing system 20 may also be configured to be interoperable across other server devices and generate information in a format that is compatible with other programs. In some embodiments, one or more of the functionality of the computing system 20 may be performed at the respective devices 12 and/or 14. Further discussion of the computing system 20 is described below in association with FIG. 4.

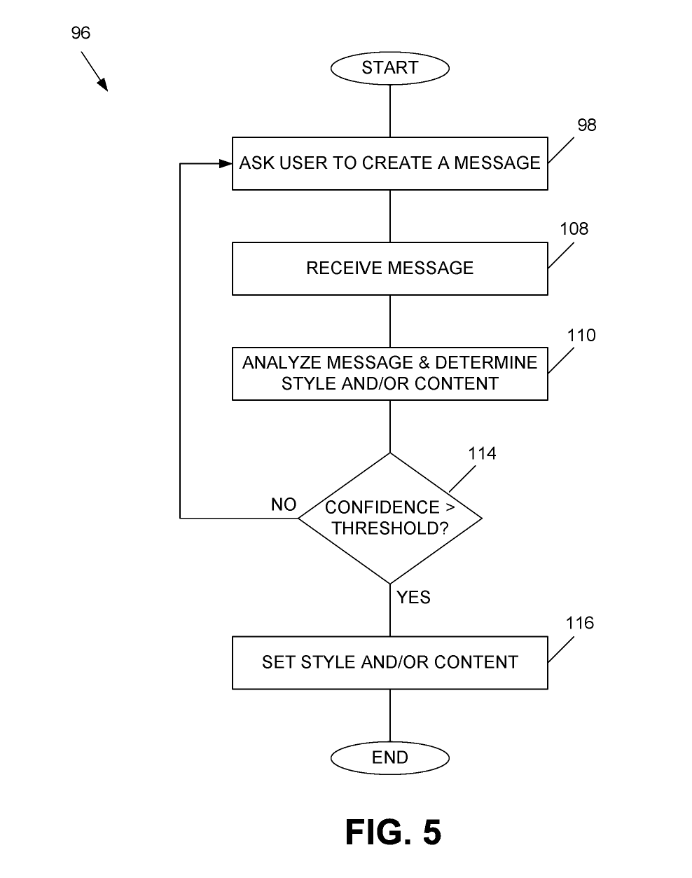

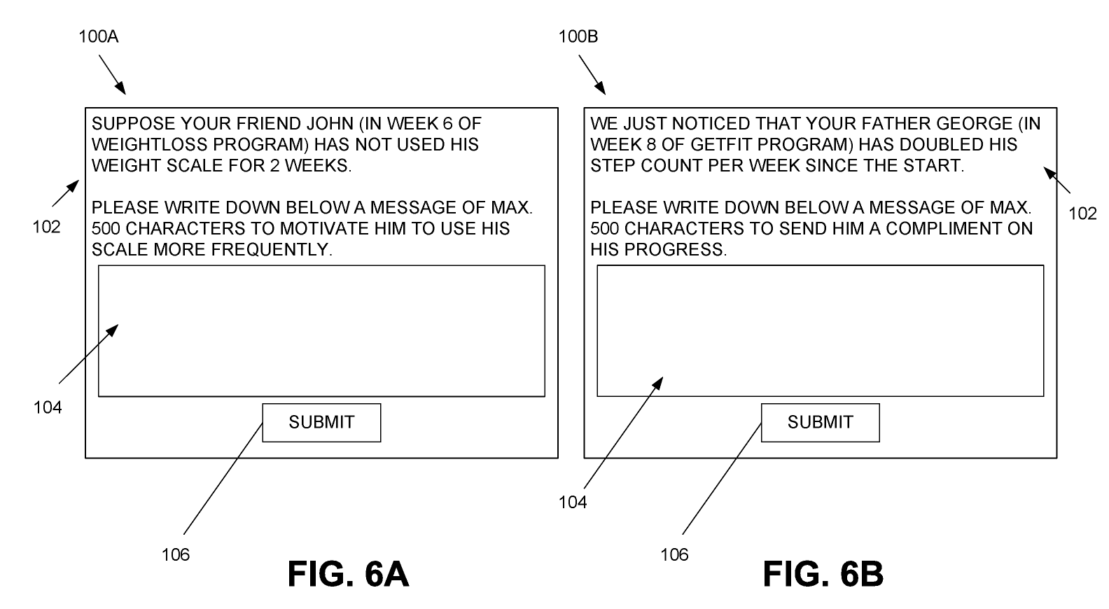

As one illustrative example of operations of an embodiment of a rapport building virtual assistant system, in accordance with a client-server application (e.g., fitness or health related application, though other types of applications including those for business, rehab, training, instruction, etc. may be run), the wearable device 12 may monitor activity of the user, and communicate sensed parameters (e.g., movement data, physiological data, etc.) to the electronics device 14. The electronics device 14 may ascertain the context of the data (e.g., the location, emotional state, etc.), communicate the data to the computing system 20 (e.g., for storage in a user profile). The electronics device 14 may receive additional input. For instance, the electronics device 14 may present one or more user interfaces that enable the user to compose (including record, such as video and/or audio) a motivational message to a peer (e.g., another person similar to himself or herself), friend, or relative, as described further below in association with FIGS. 6A-6B. The inputted motivational message and data is either processed (e.g., analyzed), or communicated to one or more devices of the remote computing system 20 for processing (e.g., semantic and syntactic analysis of the composed motivational message). In some embodiments, the motivational messages of the user may be extracted from messages of the user extracted from social media websites, blogs, chat rooms, etc. As indicated above, the wearable device 12, electronic device 14, and the computing system 20 may be operating under a health and wellness program that monitors the performance and/or progress of the user under the program and provides electronic messaging to the user to motivate an improvement in (e.g., positively impact) behavior (e.g., to make progress towards one or more goals configured in the health and wellness program, to instruct, etc.). The device or devices of the remote computing system 20 may record the performance related data and context in a user profile, as indicated above, and use semantic and syntactic analysis of the received user-crafted motivational message to determine with a threshold degree of confidence a coaching style and/or content personalized to the user and for use in future messaging to the user to optimally establish rapport. Should the computing system 20 determine that the confidence in the analysis does not rise to the threshold level of confidence, the computing system 20 may signal the electronic device 14 of that fact, triggering the electronics device 14 to present one or more additional user interfaces to enable the user to craft one or more additional motivational messages for analysis. Assuming the threshold level of confidence is reached, the computing system 20 sets the coaching style and/or content by selecting messages (e.g., from a data structure of coaching messages accessed by the computing system 20) that fit the coaching style and/or content determined from the analysis with confidence. The computing system 20 coaches the user by sending future electronic messages according to the set coaching style and/or content to the wearable device 12 and/or electronics device 14. Further description of example processing by certain embodiments of a rapport building virtual assistant system are described further below in association with FIG. 5.

Attention is now directed to FIG. 2, which illustrates an example wearable device 12 in which all or a portion of the functionality of a rapport building virtual assistant system may be implemented. That is, FIG. 2 illustrates an example architecture (e.g., hardware and software) for the example wearable device 12. It should be appreciated by one having ordinary skill in the art in the context of the present disclosure that the architecture of the wearable device 12 depicted in FIG. 2 is but one example, and that in some embodiments, additional, fewer, and/or different components may be used to achieve similar and/or additional functionality. In one embodiment, the wearable device 12 comprises a plurality of sensors 22 (e.g., 22A-22N), one or more signal conditioning circuits 24 (e.g., SIG COND CKT 24A-SIG COND CKT 24N) coupled respectively to the sensors 22, and a processing circuit 26 (PROCES CKT) that receives the conditioned signals from the signal conditioning circuits 24. In one embodiment, the processing circuit 26 comprises an analog-to-digital converter (ADC), a digital-to-analog converter (DAC), a microcontroller unit (MCU), a digital signal processor (DSP), and memory (MEM) 28. In some embodiments, the processing circuit 26 may comprise fewer or additional components than those depicted in FIG. 2. For instance, in one embodiment, the processing circuit 26 may consist entirely of the microcontroller. In some embodiments, the processing circuit 26 may include the signal conditioning circuits 24. The memory 28 comprises an operating system (OS) and application software (ASW) 30, which may be used to execute a particular health and wellness program for a user (or in some embodiments, business program, rehabilitation program, training program, etc.). In the depicted embodiment, the application software 30 comprises a sensor measurement module (SMM) 32, an interface module (IM) 34 and communications module (CM) 36. In some embodiments, additional modules used to achieve the disclosed functionality of a rapport building virtual assistant system, among other functionality, may be included, or one or more of the modules 32-36 may be separate from the application software 30.

The sensor measurement module 32 comprises executable code (instructions) to process the signals (and associated data) measured by the sensors 22 and record and/or derive physiological parameters, such as heart rate, blood pressure, respiration, perspiration, etc. and movement and/or location data. In some embodiments, the sensor measurement module 32 may comprise location positioning software (e.g., in cooperation with GNSS receiver functionality included among the sensors 22). The measured information (or information derived from the measured information) may be used in some embodiments of a rapport building virtual assistant system to provide context for messages created by a user, including the emotional or psychological state of the user, which may enable or facilitate determinations of when to present electronic messages or help establish a content and/or style for the messages. In some embodiments, the sensor measurements may not be used in the rapport building virtual assistant system.

The interface module 34 comprises executable code (instructions) to enable the presentation of electronic messages of a configured coaching style and/or content. In some embodiments, the interface module 34 may comprise functionality to enable the input (via voice or typed entry) of a specific motivational message to a peer or other person, but for purposes of illustration, the capability for enabling input of such a message is described as functionality of the electronic device 14 (FIG. 3), as described further below.

The communications module 36 comprises executable code (instructions) to enable a communications circuit 38 of the wearable device 12 to operate according to one or more of a plurality of different communication technologies (e.g., NFC, Bluetooth, Zigbee, etc.). For purposes of illustration, the communications module 36 is described herein as providing for control of communications with the electronics device 14. For instance, the communications module 36, in cooperation with the communications circuit 38, provide for the transmission of raw sensor data and/or the derived information from the sensor data to the electronics device 14 (which communicates the same or data derived from the same) to the computing system 20. Further, the communications module 36, in cooperation with the communications circuit 38, receives user-composed motivational messages from the electronics device 14. However, in some embodiments, the communications module 36 instructs and/or controls the communications circuit 38 to transmit data to, and receive data from, the computing system 20 (e.g., directly via the cellular network 16 and/or Internet). In the latter configuration, the communications module 36 may also include browser software in some embodiments to enable Internet connectivity, and may also be used to access certain services, such as mapping/place location services, which may be used to determine a context for the sensor data. These services may be used in some embodiments of a rapport building virtual assistant system, and in some instances, may not be used. In some embodiments, the location services may be performed by a client-server application running on the electronics device 14 and a device of the remote computing system 20. Further, as noted above, some embodiments of the wearable device 12 may comprise all functionality of an embodiment of a rapport building virtual assistant system (e.g., the receipt of a composed message to a peer or other person, the processing of the composed message, the presentation of subsequent messages based on the coaching style and/or content determined from the analysis).

As indicated above, in one embodiment, the processing circuit 26 is coupled to the communications circuit 38. The communications circuit 38 serves to enable wireless communications between the wearable device 12 and other devices, including the electronics device 14 and/or in some embodiments, device(s) of the computing system 20, among other devices. The communications circuit 38 is depicted as a Bluetooth circuit, though not limited to this transceiver configuration. For instance, in some embodiments, the communications circuit 38 may be embodied as any one or a combination of an NFC circuit, Wi-Fi circuit, transceiver circuitry based on Zigbee, 802.11, GSM, LTE, CDMA, WCDMA, among others such as optical or ultrasonic based technologies. The processing circuit 26 is further coupled to input/output (I/O) devices or peripherals, including an input interface 40 (INPUT) and the output interface 42 (OUT). Note that in some embodiments, functionality for one or more of the aforementioned circuits and/or software may be combined into fewer components/modules, or in some embodiments, further distributed among additional components/modules or devices. For instance, the processing circuit 26 may be packaged as an integrated circuit that includes the microcontroller (microcontroller unit or MCU), the DSP, and memory 28, whereas the ADC and DAC may be packaged as a separate integrated circuit coupled to the processing circuit 26. In some embodiments, one or more of the functionality for the above-listed components may be combined, such as functionality of the DSP performed by the microcontroller.

The sensors 22 are selected to perform detection and measurement of a plurality of physiological and behavioral parameters. For instance, typical physiological parameters include heart rate, heart rate variability, heart rate recovery, blood flow rate, activity level, muscle activity (e.g., movement of limbs, repetitive movement, core movement, body orientation/position, power, speed, acceleration, etc.), muscle tension, blood volume, blood pressure, blood oxygen saturation, respiratory rate, perspiration, skin temperature, body weight, and body composition (e.g., body mass index or BMI). Typical behavioral parameters or activities including walking, running, cycling, and/or other activities, including shopping, walking a dog, working in the garden, sports activities, etc.). At least one of the sensors 22 may be embodied as movement detecting sensors, including inertial sensors (e.g., gyroscopes, single or multi-axis accelerometers, such as those using piezoelectric, piezoresistive or capacitive technology in a microelectromechanical system (MEMS) infrastructure for sensing movement). In some embodiments, at least one of the sensors 22 may include GNSS sensors, including a GPS receiver to facilitate determinations of distance, speed, acceleration, location, altitude, etc. (e.g., location data, or generally, sensing movement), in addition to or in lieu of the accelerometer/gyroscope and/or indoor tracking (e.g., ibeacon™, WiFi, coded-light based technology, etc.). In some embodiments, GNSS sensors (e.g., GNSS receiver and antenna(s)) may be included in the electronics device 14 in addition to, or in lieu of, those residing in the wearable device 12. The sensors 22 may also include flex and/or force sensors (e.g., using variable resistance), electromyographic sensors, electrocardiographic sensors (e.g., EKG, ECG), magnetic sensors, photoplethysmographic (PPG) sensors, bio-impedance sensors, infrared proximity sensors, acoustic/ultrasonic/audio sensors, a strain gauge, galvanic skin/sweat sensors, pH sensors, temperature sensors, pressure sensors, and photocells. The sensors 22 may include other and/or additional types of sensors for the detection of, for instance, barometric pressure, humidity, outdoor temperature, etc. In some embodiments, GNSS functionality may be achieved via the communications circuit 38 or other circuits coupled to the processing circuit 26.

The signal conditioning circuits 24 include amplifiers and filters, among other signal conditioning components, to condition the sensed signals including data corresponding to the sensed physiological parameters and/or location signals before further processing is implemented at the processing circuit 26. Though depicted in FIG. 2 as respectively associated with each sensor 22, in some embodiments, fewer signal conditioning circuits 24 may be used (e.g., shared for more than one sensor 22). In some embodiments, the signal conditioning circuits 24 (or functionality thereof) may be incorporated elsewhere, such as in the circuitry of the respective sensors 22 or in the processing circuit 26 (or in components residing therein). Further, although described above as involving unidirectional signal flow (e.g., from the sensor 22 to the signal conditioning circuit 24), in some embodiments, signal flow may be bi-directional. For instance, in the case of optical measurements, the microcontroller may cause an optical signal to be emitted from a light source (e.g., light emitting diode(s) or LED(s)) in or coupled to the circuitry of the sensor 22, with the sensor 22 (e.g., photocell) receiving the reflected/refracted signals.

The communications circuit 38 is managed and controlled by the processing circuit 26 (e.g., executing the communications module 36). The communications circuit 38 is used to wirelessly interface with the electronics device 14 (FIG. 3) and/or in some embodiments, one or more devices of the computing system 20. In one embodiment, the communications circuit 38 may be configured as a Bluetooth transceiver, though in some embodiments, other and/or additional technologies may be used, such as Wi-Fi, GSM, LTE, CDMA and its derivatives, Zigbee, NFC, among others. In the embodiment depicted in FIG. 2, the communications circuit 38 comprises a transmitter circuit (TX CKT), a switch (SW), an antenna, a receiver circuit (RX CKT), a mixing circuit (MIX), and a frequency hopping controller (HOP CTL). The transmitter circuit and the receiver circuit comprise components suitable for providing respective transmission and reception of an RF signal, including a modulator/demodulator, filters, and amplifiers. In some embodiments, demodulation/modulation and/or filtering may be performed in part or in whole by the DSP. The switch switches between receiving and transmitting modes. The mixing circuit may be embodied as a frequency synthesizer and frequency mixers, as controlled by the processing circuit 26. The frequency hopping controller controls the hopping frequency of a transmitted signal based on feedback from a modulator of the transmitter circuit. In some embodiments, functionality for the frequency hopping controller may be implemented by the microcontroller or DSP. Control for the communications circuit 38 may be implemented by the microcontroller, the DSP, or a combination of both. In some embodiments, the communications circuit 38 may have its own dedicated controller that is supervised and/or managed by the microcontroller.

In one example operation, a signal (e.g., at 2.4 GHz) may be received at the antenna and directed by the switch to the receiver circuit. The receiver circuit, in cooperation with the mixing circuit, converts the received signal into an intermediate frequency (IF) signal under frequency hopping control attributed by the frequency hopping controller and then to baseband for further processing by the ADC. On the transmitting side, the baseband signal (e.g., from the DAC of the processing circuit 26) is converted to an IF signal and then RF by the transmitter circuit operating in cooperation with the mixing circuit, with the RF signal passed through the switch and emitted from the antenna under frequency hopping control provided by the frequency hopping controller. The modulator and demodulator of the transmitter and receiver circuits may perform frequency shift keying (FSK) type modulation/demodulation, though not limited to this type of modulation/demodulation, which enables the conversion between IF and baseband. In some embodiments, demodulation/modulation and/or filtering may be performed in part or in whole by the DSP. The memory 28 stores the communications module 36, which when executed by the microcontroller, controls the Bluetooth (and/or other protocols) transmission/reception.

Though the communications circuit 38 is depicted as an IF-type transceiver, in some embodiments, a direct conversion architecture may be implemented. As noted above, the communications circuit 38 may be embodied according to other and/or additional transceiver technologies.

The processing circuit 26 is depicted in FIG. 2 as including the ADC and DAC. For sensing functionality, the ADC converts the conditioned signal from the signal conditioning circuit 24 and digitizes the signal for further processing by the microcontroller and/or DSP. The ADC may also be used to convert analogs inputs that are received via the input interface 40 to a digital format for further processing by the microcontroller. The ADC may also be used in baseband processing of signals received via the communications circuit 38. The DAC converts digital information to analog information. Its role for sensing functionality may be to control the emission of signals, such as optical signals or acoustic signals, from the sensors 22. The DAC may further be used to cause the output of analog signals from the output interface 42. Also, the DAC may be used to convert the digital information and/or instructions from the microcontroller and/or DSP to analog signals that are fed to the transmitter circuit. In some embodiments, additional conversion circuits may be used.

The microcontroller and the DSP provide processing functionality for the wearable device 12. In some embodiments, functionality of both processors may be combined into a single processor, or further distributed among additional processors. The DSP provides for specialized digital signal processing, and enables an offloading of processing load from the microcontroller. The DSP may be embodied in specialized integrated circuit(s) or as field programmable gate arrays (FPGAs). In one embodiment, the DSP comprises a pipelined architecture, which comprises a central processing unit (CPU), plural circular buffers and separate program and data memories according to a Harvard architecture. The DSP further comprises dual busses, enabling concurrent instruction and data fetches. The DSP may also comprise an instruction cache and I/O controller, such as those found in Analog Devices SHARC® DSPs, though other manufacturers of DSPs may be used (e.g., Freescale multi-core MSC81xx family, Texas Instruments C6000 series, etc.). The DSP is generally utilized for math manipulations using registers and math components that may include a multiplier, arithmetic logic unit (ALU, which performs addition, subtraction, absolute value, logical operations, conversion between fixed and floating point units, etc.), and a barrel shifter. The ability of the DSP to implement fast multiply-accumulates (MACs) enables efficient execution of Fast Fourier Transforms (FFTs) and Finite Impulse Response (FIR) filtering. Some or all of the DSP functions may be performed by the microcontroller. The DSP generally serves an encoding and decoding function in the wearable device 12. For instance, encoding functionality may involve encoding commands or data corresponding to transfer of information to the electronics device 14 (or a device of the computing system 20 in some embodiments). Also, decoding functionality may involve decoding the information received from the sensors 22 (e.g., after processing by the ADC).

The microcontroller comprises a hardware device for executing software/firmware, particularly that stored in memory 28. The microcontroller can be any custom made or commercially available processor, a central processing unit (CPU), a semiconductor based microprocessor (in the form of a microchip or chip set), a macroprocessor, or generally any device for executing software instructions. Examples of suitable commercially available microprocessors include Intel's® Itanium® and Atom® microprocessors, to name a few non-limiting examples. The microcontroller provides for management and control of the wearable device 12, including determining physiological parameters or location coordinates based on the sensors 22, and for enabling communication with the electronics device 14 (and/or a device of the computing system 20 in some embodiments).

The memory 28 can include any one or a combination of volatile memory elements (e.g., random access memory (RAM, such as DRAM, SRAM, SDRAM, etc.)) and nonvolatile memory elements (e.g., ROM, Flash, solid state, EPROM, EEPROM, etc.). Moreover, the memory 28 may incorporate electronic, magnetic, and/or other types of storage media.

The software in memory 28 may include one or more separate programs, each of which comprises an ordered listing of executable instructions for implementing logical functions. In the example of FIG. 2, the software in the memory 28 includes a suitable operating system and the application software 30, which in one embodiment, runs a health and wellness program (though programs for other services, including business, training, etc. may be used) that includes a plurality of software modules 32-36 for implementing certain embodiments of a rapport building virtual assistant system and algorithms for determining physiological and/or behavioral measures and/or other information (e.g., including location, speed of travel, etc.) based on the output from the sensors 22. The raw data from the sensors 22 may be used by algorithms of the sensor measurement module 32 to determine various physiological and/or behavioral measures (e.g., heart rate, biomechanics, such as swinging of the arms), and may also be used to derive other parameters, such as energy expenditure, heart rate recovery, aerobic capacity (e.g., VO2 max, etc.), among other derived measures of physical performance. In some embodiments, these derived parameters may be computed externally (e.g., at the electronics devices 14 or one or more devices of the computing system 20) in lieu of, or in addition to, the computations performed local to the wearable device 12.

The operating system essentially controls the execution of computer programs, such as the application software 30 and associated modules 32-36, and provides scheduling, input-output control, file and data management, memory management, and communication control and related services. The memory 28 may also include user data, including weight, height, age, gender, goals, body mass index (BMI) that are used by the microcontroller executing the executable code of the algorithms to accurately interpret the measured physiological, psychological, and/or behavioral data. The user data may also include historical data relating past recorded data to prior contexts. In some embodiments, user data may be stored elsewhere (e.g., at the electronics device 14 and/or a device of the remote computing system 20).

The software in memory 28 comprises a source program, executable program (object code), script, or any other entity comprising a set of instructions to be performed. When a source program, then the program may be translated via a compiler, assembler, interpreter, or the like, so as to operate properly in connection with the operating system. Furthermore, the software can be written as (a) an object oriented programming language, which has classes of data and methods, or (b) a procedure programming language, which has routines, subroutines, and/or functions, for example but not limited to, C, C++, Python, Java, among others. The software may be embodied in a computer program product, which may be a non-transitory computer readable medium or other medium.

The input interface(s) 40 comprises one or more interfaces (e.g., including a user interface) for entry of user input, such as a button or microphone or sensor (e.g., to detect user input) or touch-type display screen. In some embodiments, the input interface 40 may serve as a communications port for downloaded information to the wearable device 12 (such as via a wired connection). The output interface(s) 42 comprises one or more interfaces for the presentation or transfer of data, including a user interface (e.g., display screen presenting a graphical user interface) or communications interface for the transfer (e.g., wired) of information stored in the memory, or to enable one or more feedback devices, such as lighting devices (e.g., LEDs), audio devices (e.g., tone generator and speaker), and/or tactile feedback devices (e.g., vibratory motor). For instance, the output interface 42 may be used to present the personalized electronic messages to the user in some embodiments. In some embodiments, at least some of the functionality of the input and output interfaces 40 and 42, respectively, may be combined, including being embodied at least in part as a touch-type display screen for the entry of input and/or presentation of tailored motivational messages, among other data.

Referring now to FIG. 3, shown is an example electronics device 14 in which all or a portion of the functionality of a rapport building virtual system may be implemented. In the depicted example, the electronics device 14 is embodied as a smartphone (hereinafter, referred to as smartphone 14), though in some embodiments, other types of devices may be used, including a workstation, laptop, notebook, tablet, home or auto appliance, etc. It should be appreciated by one having ordinary skill in the art that the logical block diagram depicted in FIG. 3 and described below is one example, and that other designs may be used in some embodiments. The application software 30A, which may include functionality to run a health and wellness (e.g., fitness) program, among other programs, comprises a plurality of software modules (e.g., executable code/instructions) including an optional position determining module (PDM) 44, communications module (CM) 46, and an interface module (IM) 48. In some embodiments, the application software 30A may include additional software modules or fewer software modules. For instance, as described above, in some embodiments, the application software 30A may comprise all of the functionality of the rapport building virtual assistant system (e.g., functionality for semantic and syntactic analysis, a data structure comprising coaching messages, etc.), or a subset thereof in some embodiments. In the illustrative embodiment depicted in FIG. 3, it is assumed that the application software 30A comprises functionality (interface module 48) to enable a user to input a motivational message and present personalized electronic messages of a configured style and/or content based on analysis by the computing system 20). The smartphone 14 comprises at least two different processors, including a baseband processor (BBP) 50 and an application processor (APP) 52. As is known, the baseband processor 50 primarily handles baseband communication-related tasks and the application processor 52 generally handles inputs and outputs and all applications other than those directly related to baseband processing. The baseband processor 50 comprises a dedicated processor for deploying functionality associated with a protocol stack (PROT STK), such as a GSM (Global System for Mobile communications) protocol stack, among other functions. The application processor 52 comprises a multi-core processor for running applications, including all or a portion of the application software 30A and its corresponding component modules 44-48. The baseband processor 50 and application processor 52 have respective associated memory (e.g., MEM) 54, 56, including random access memory (RAM), Flash memory, etc., and peripherals, and a running clock. Note that, though depicted as residing in memory 56, all or a portion of the modules 44-48 of the application software 30A may be stored in memory 54, distributed among memory 54, 56, or reside in other memory.

More particularly, the baseband processor 50 may deploy functionality of the protocol stack to enable the smartphone 14 to access one or a plurality of wireless network technologies, including WCDMA (Wideband Code Division Multiple Access), CDMA (Code Division Multiple Access), EDGE (Enhanced Data Rates for GSM Evolution), GPRS (General Packet Radio Service), Zigbee (e.g., based on IEEE 802.15.4), Bluetooth, Wi-Fi (Wireless Fidelity, such as based on IEEE 802.11), and/or LTE (Long Term Evolution), among variations thereof and/or other telecommunication protocols, standards, and/or specifications. The baseband processor 50 manages radio communications and control functions, including signal modulation, radio frequency shifting, and encoding. The baseband processor 50 comprises, or may be coupled to, a radio (e.g., RF front end) 58 and/or a GSM modem, and analog and digital baseband circuitry (ABB, DBB, respectively in FIG. 3). The radio 58 comprises one or more antennas, a transceiver, and a power amplifier to enable the receiving and transmitting of signals of a plurality of different frequencies, enabling access to the cellular network 16 (FIG. 1), and hence the communication of user data, activity data, and associated contexts to the computing system 20 (FIG. 1) and the receipt of or access to personalized coaching messages from the computing system 20. The analog baseband circuitry is coupled to the radio 58 and provides an interface between the analog and digital domains of the GSM modem. The analog baseband circuitry comprises circuitry including an analog-to-digital converter (ADC) and digital-to-analog converter (DAC), as well as control and power management/distribution components and an audio codec to process analog and/or digital signals received indirectly via the application processor 52 or directly from the smartphone user interface (UI) 60 (e.g., microphone, earpiece, ring tone, vibrator circuits, touch-screen, etc.). The ADC digitizes any analog signals for processing by the digital baseband circuitry. The digital baseband circuitry deploys the functionality of one or more levels of the GSM protocol stack (e.g., Layer 1, Layer 2, etc.), and comprises a microcontroller (e.g., microcontroller unit or MCU, also referred to herein as a processor) and a digital signal processor (DSP, also referred to herein as a processor) that communicate over a shared memory interface (the memory comprising data and control information and parameters that instruct the actions to be taken on the data processed by the application processor 52). The MCU may be embodied as a RISC (reduced instruction set computer) machine that runs a real-time operating system (RTIOS), with cores having a plurality of peripherals (e.g., circuitry packaged as integrated circuits) such as RTC (real-time clock), SPI (serial peripheral interface), I2C (inter-integrated circuit), UARTs (Universal Asynchronous Receiver/Transmitter), devices based on IrDA (Infrared Data Association), SD/MMC (Secure Digital/Multimedia Cards) card controller, keypad scan controller, and USB devices, GPRS crypto module, TDMA (Time Division Multiple Access), smart card reader interface (e.g., for the one or more SIM (Subscriber Identity Module) cards), timers, and among others. For receive-side functionality, the MCU instructs the DSP to receive, for instance, in-phase/quadrature (I/Q) samples from the analog baseband circuitry and perform detection, demodulation, and decoding with reporting back to the MCU. For transmit-side functionality, the MCU presents transmittable data and auxiliary information to the DSP, which encodes the data and provides to the analog baseband circuitry (e.g., converted to analog signals by the DAC).

The application processor 52 operates under control of an operating system (OS) that enables the implementation of a plurality of user applications, including the application software 30A (e.g., a health and wellness program, though others may be used). The application processor 52 may be embodied as a System on a Chip (SOC), and supports a plurality of multimedia related features including web browsing functionality of the communications module 46 to access one or more computing devices of the computing system 20 (FIG. 4) that are coupled to the Internet, email, multimedia entertainment, games, etc. For instance, the application processor 52 may execute the communications module 46 (e.g., middleware, such as a browser with or operable in association with one or more application program interfaces (APIs)) to enable access to a cloud computing framework or other networks to provide remote data access/storage/processing, and through cooperation with an embedded operating system, access to calendars, location services, reminders, etc. For instance, in some embodiments, the rapport building virtual assistant system may operate using cloud computing, where the processing of sensor data received (indirectly via the smartphone 14 or directly) from the wearable device 12 and context data (e.g., location data) and user inputted data or other data received from the smartphone 14, including sensed data from the smartphone (e.g., motion sense, accelerations, speed of travel, imaging, radio tag information (e.g., RFID), etc.), may be achieved by one or more devices of the computing system 20. The application processor 52 generally comprises a processor core (Advanced RISC Machine or ARM), and further comprises or may be coupled to multimedia modules (for decoding/encoding pictures, video, and/or audio), a graphics processing unit (GPU), communications interface (COMM) 62, and device interfaces. In one embodiment, the communication interfaces 62 may include wireless interfaces, including a Bluetooth (BT) (and/or Zigbee in some embodiments) module that enable wireless communication with an electronics device, including the wearable device 12, other electronics devices, and a Wi-Fi module for interfacing with a local 802.11 network, according to corresponding software in the communications module 46. The application processor 52 further comprises, or in the depicted embodiment, is coupled to, a global navigation satellite systems (GNSS) transceiver or receiver (GNSS) 64 for enabling access to a satellite network to, for instance, provide coordinate location services. In some embodiments, the GNSS receiver 64, in association with GNSS functionality in the application software 30A (e.g., as part of the position determining module (PDM) 44, or in some embodiments, as a separate module), collects contextual data (time and location data, including location coordinates and altitude), and provides a time stamp to the information provided to a device or devices of the computing system 20. In some embodiments, the application software 30A may compute speed of movement of the smartphone 14 (and/or other sensor data, including acceleration data) for provision of the contextual information (e.g., meta information) to the remote computing system 20. For instance, the application software 30A may also collect information about the means of ambulation, where the GNSS data (which may include time coordinates) may be used by the application software 30A to determine speed of travel, which may indicate whether the user is moving within a vehicle, on a bicycle, or walking or running. In some embodiments, other and/or additional data may be used to assess the type of activity, including physiological data (e.g., heart rate, respiration rate, galvanic skin response, etc.) and/or behavioral data, enabling for instance, a determination of the emotional and/or psychological state of the user (when composing a message, for instance).

The device interfaces coupled to the application processor 52 may include the user interface 60, including a display screen. The display screen, in some embodiments similar to a display screen of the wearable device user interface, may be embodied in one of several available technologies, including LCD or Liquid Crystal Display (or variants thereof, such as Thin Film Transistor (TFT) LCD, In Plane Switching (IPS) LCD)), light-emitting diode (LED)-based technology, such as organic LED (OLED), Active-Matrix OLED (AMOLED), or retina or haptic-based technology. For instance, the interface module 48 may use the display screen to present web pages, dashboards, personalized electronic messages based on a configured style and/or content, templates for creating motivational messages, and/or other documents or data received from the computing system 20 and/or the display screen may be used to present information (e.g., personalized coaching messages, templates for crafting of motivational messages) in graphical user interfaces (GUIs) rendered locally in association with the interface module 48. Other user interfaces 60 may include a keypad, microphone, speaker, ear piece connector, I/O interfaces (e.g., USB (Universal Serial Bus)), SD/MMC card, among other peripherals. Also coupled to the application processor 52 is an image capture device (IMAGE CAPTURE) 66. The image capture device 66 comprises an optical sensor (e.g., a charged coupled device (CCD) or a complementary metal-oxide semiconductor (CMOS) optical sensor). The image capture device 66 may be used to detect various physiological parameters of a user, including blood pressure based on remote photoplethysmography (PPG). In some embodiments, the image capture device 66 may comprise a video camera, which may be used to record video as part of the composed motivational message to a peer as solicited by an embodiment of a rapport building virtual assistant system. Also included is a power management device 68 that controls and manages operations of a battery 70. The components described above and/or depicted in FIG. 3 share data over one or more busses, and in the depicted example, via data bus 72. It should be appreciated by one having ordinary skill in the art, in the context of the present disclosure, that variations to the above may be deployed in some embodiments to achieve similar functionality.

In the depicted embodiment, the application processor 52 runs the application software 30A, which in one embodiment, includes a plurality of software modules (e.g., executable code/instructions) including the position determining module 44, the communications module 46, and the interface module 48. The position determining module 44 may include GNSS functionality that operates with the GNSS receiver 64 to interpret the data to provide a location and time of the user activity. As described above, the position determining module 44 provides location coordinates (and a corresponding time) of the user based on the GNSS receiver input. In some embodiments, the position determining module 44 cooperates with local or external location servicing services, wherein the position determining module 44 receives descriptive information and converts the information to latitude and longitude coordinates. In some embodiments, the location servicing services may be handled by the communications module 46 in cooperation with the position determining module 44. In one embodiment, the communications module 46, in conjunction with the communications interface 62, enables the receipt from, and/or communication of data to, the wearable device 12 (FIG. 2). The communications module 46 may enable operations according to any one or more of a variety of technologies, including BT, NFC, RFID, etc. The communications module 46 further includes network interfacing software, including browser software, to access the Internet (and in particular, one or more devices of the computing system 20). The interface module 48 may render a GUI on the display screen (e.g., user interface 60) based on receipt of electronic messages comprising motivational messages of a configured (set and personalized) coaching style and/or content from the remote computing system 20. The interface module 48 also is configured to render a GUI that comprises a template within which a user can prepare a motivational message for a peer of similar character/traits, friend, relative, etc. In one embodiment, the GUI may be locally generated, or in some embodiments, the GUI may comprise one or more web pages provided by the remote computing system 20. Within or associated with additional GUIs are one or more personalized coaching messages intended at least in part to influence a change in behavior of the user (e.g., by providing feedback of progress towards a goal and/or to train or educate). In some embodiments, the personalized coaching messages may be presented with a dashboard of activity performance and/or physiological measures, or in some embodiments, the dashboard may be presented separately. In some embodiments, the dashboard may include population statistics used for comparative measures, which may be drawn from social websites according to one or more APIs or other databases (e.g., medical institution databases, coaching databases, user database(s), etc.). In some embodiments, the interface module 48 works in cooperation with audio recording functionality of the UI 60 or video or image recording functionality of the image capture device 66 to enable video and/or audio recordings of the motivational message composed by the user and/or the receipt and playback of personalized electronic messages to be presented based on analysis of the composed messages. In some embodiments, one or more of the software modules and/or corresponding functionality of the application software 30A may be further distributed among additional software modules, or in some embodiments, performed at other devices in addition to, or in lieu of, implementation at the smartphone 14. The application software 30A may also comprises executable code to process the signals (and associated data) measured by the sensors (of the wearable device 12 as communicated to the smartphone 14, or based on sensors integrated within the smartphone 14) and record and/or derive physiological parameters, such as heart rate, blood pressure, respiration, perspiration, etc. Note that all or a portion of the aforementioned hardware and/or software of the smartphone 14 may also be referred to herein as a processing circuit in some embodiments.

Referring now to FIG. 4, shown is a computing device 74 that may comprise a device or devices of the remote computing system 20 (FIG. 1) and which may comprise all or a portion of the functionality of a rapport building virtual assistant system. Functionality of the computing device 74 may be implemented within a single computing device as shown here, or in some embodiments, may be implemented among plural devices (i.e., that collectively perform the functionality described below). In one embodiment, the computing device 74 may be embodied as an application server device, a computer, among other computing devices. One having ordinary skill in the art should appreciate in the context of the present disclosure that the example computing device 74 is merely illustrative of one embodiment, and that some embodiments of computing devices may comprise fewer or additional components, and/or some of the functionality associated with the various components depicted in FIG. 4 may be combined, or further distributed among additional modules or computing devices in some embodiments. The computing device 74 is depicted in this example as a computer system, including a computer system providing functionality of an application server. It should be appreciated that certain well-known components of computer systems are omitted here to avoid obfuscating relevant features of the computing device 74. In one embodiment, the computing device 74 comprises a processing circuit 76 comprising hardware and software components. In some embodiments, the processing circuit 76 may comprise additional components or fewer components. For instance, memory may be separate from the processing circuit 76. The processing circuit 76 comprises one or more processors, such as processor 78 (PROCES), input/output (I/O) interface(s) 80 (I/O), and memory 82 (MEM), all coupled to one or more data busses, such as data bus 84 (DBUS). The memory 82 may include any one or a combination of volatile memory elements (e.g., random-access memory RAM, such as DRAM, and SRAM, etc.) and nonvolatile memory elements (e.g., ROM, Flash, solid state, EPROM, EEPROM, hard drive, tape, CDROM, etc.). The memory 82 may store a native operating system (OS), one or more native applications, emulation systems, or emulated applications for any of a variety of operating systems and/or emulated hardware platforms, emulated operating systems, etc. In some embodiments, the processing circuit 76 may include, or be coupled to, one or more separate storage devices.

For instance, in the depicted embodiment, the processing circuit 76 is coupled via the I/O interfaces 80 to user profile data structures (UPDS) 86 and a coaching messages data structures (CMDS) 88, explained further below. In some embodiments, the user profile data structures 86 and coaching messages data structures 88 may be coupled to the processing circuit 76 directly via the data bus 84 (e.g., stored in a storage device (STOR DEV)) or coupled to the processing circuit 76 via the I/O interfaces 80 and the network 18 via one or more network-connected storage devices. In some embodiments, the user profile data structures 86 and coaching messages data structures 88 may be stored in a single device or distributed among plural devices. Though described as separate data structures, in some embodiments, the content stored by the user profile data structures 86 and coaching messages data structures 88 may be combined into a single data structure. The user profile data structures 86 and coaching messages data structures 88 may be stored in persistent memory (e.g., optical, magnetic, and/or semiconductor memory and associated drives). In some embodiments, the user profile data structures 86 and coaching messages data structures 88 may be stored in memory 82. The user profile data structures 86 are configured to store user profile data. In one embodiment, the user profile data comprises demographics and user-composed motivational messages, and further includes user-configured message delivery configurations (e.g., settings as to the manner of delivery desired by the user (writer) of motivational messages). As described above, in one embodiment, the user-composed motivational messages are inputted at the electronic device 14 (e.g., written and/or recorded) and communicated to the computing device 74. Though described in the context of the composed electronic message being prompted (e.g., requested by) the rapport building virtual assistant system, in some embodiments, the composed messages of the user may be harvested from existing personal resources, including from social media websites where the user has written motivational messages to others, or from a blog or from a patient sharing group, among other sources. Additional description of an example manner in which the user may enter the motivational messages are described further in association with FIGS. 6A-6B. The user profile data structures 86 (and in particular, the composed motivational messages) may be accessed by the processor 78 executing software in memory 82 to determine a coaching style and/or content, and then matched with coaching messages of a corresponding coaching style and/or content via comparison with the coaching messages stored in the coaching messages data structures 88. In some embodiments, the coaching messages data structures 88 may be updated based on the analysis. In some embodiments, one or more of the content stored in the user profile data structures 86 may also be stored as meta information in the coaching messages data structures 88. The user profile data structure 86 may also include current or contemporaneous activity data for the user that is communicated to the computing device 74 during synch operations with the smartphone 14 and/or wearable device 12 or as communicated from a third party server device (e.g., medical facility, fitness tracking service, etc.). Additional data structures may be used to record similar information for other users.

In one embodiment, the coaching messages data structures 88 comprises the total set of possible coaching messages. For instance, the coaching messages data structures 88 may be configured as one or more databases that are built up of all the generated coaching messages tagged with the specific features that result from semantic and syntactic analysis of the motivational messages composed by the user, as described further below. The coaching messages may be clustered or tagged according to specific communication styles (or coaching approaches), which enables certain embodiments of a rapport building virtual system to filter out only those messages that fit the communication style or approach of the user as derived from analysis of the composed motivational messages. In some embodiments, all generated coaching messages are stored in the coaching messages data structures 88 and tagged with the specific list of features that resulted from the analysis as illustratively described in Table 1 below. In this way the database can be maintained by the computing system 20 (FIG. 1) and increases over time. In other words, the coaching messages data structures 88 may be fixed (a pre-generated and annotated data structure) in content or dynamic (updated, such as storing the received composed motivational messages in the data structure for reuse later in the same process to match with new input messages). In some embodiments, the coaching messages may comprise message templates to enable completion of the blanks, fields and/or variables in the message with personalized information of the user. In some embodiments, the coaching messages included in the coaching messages data structures 88 may be initially configured by an administrator operating the computing system 20 and/or computing device 74. In some embodiments, the user profile data structures 86 and coaching messages data structures 88 may serve as backend storage of the computing system 20 as well as network storage and/or cloud storage. The user profile data structures 86 may be updated periodically, aperiodically, and/or in response to analysis of a composed message.

In the embodiment depicted in FIG. 4, the memory 82 comprises an operating system (OS) and application software (ASW) 30B, the latter which may execute a health and wellness program, among other programs in some embodiments. The application software 30B comprises a message processing engine 90, which comprises one or more modules of executable code (instructions) that analyze written text (TEXT), audio (AUDIO), and/or video (VIDEO) from composed messaging (including recordings) sent to the computing device 74 from the wearable device 12 and/or electronics device 14 (or received from social media or other sites containing user-composed messages), as explained further below. Note that text analysis includes emoticon analysis, from which the message processing engine 90 can infer a coaching style and/or content. The application software 30B further comprises performance monitoring module (PMM) 92 that analyzes measurements and/or user-inputted profile data from the wearable device 12 and/or smartphone 14 (e.g., accessed from the user profile data structure 86) as part of the health and wellness program. For instance, the performance monitoring module 92 receives and analyzes the activity data, demographics, etc. of the user and provides a dashboard of information that may include progress towards a given goal (e.g., fitness goals), comparisons to the general population (or user-configured population of people), and/or performance data for various activities (e.g., physiological measurements, derived measurements including caloric loss, energy expenditure, etc.). The performance monitoring module 92 may also provide feedback to the message processing engine 90 as to emotional or psychological status of a user based on the physiological measures (or the message processing engine 90 may interpret the physiological data to derive the same) at a time corresponding to the composing of a message, such as to further determine the content and/or style (and/or manner of delivery) of future electronic messages. The application software 30B further comprises a communications module (CM) 94 that receives the activity data/user profile data from the wearable device 12 and/or electronics device 14, and also communicates scenarios to prompt motivational message composition and/or electronic messages comprising messages of a set style and/or content to the wearable device 12 and/or the electronics device 14. The user profile data, composed messages, and/or coaching messages of the set coaching style and/or content may be accessed by the application software 30B from the user profile data structure 86 and the coaching messages data structures 88. The communications module 94 generally enables communications among network-connected devices and provides web and/or cloud services, among other software such as via one or more APIs. In some embodiments, the communications module 94 may be separate from the application software 30B. In one example operation, the communications module 94 may receive (via I/O interfaces 80) input data from the wearable device 12 and/or the electronics device 14 that includes sensed data, context data, user-inputted data, data from third-party databases (e.g., medical data base, health program provider data, etc.), data from social media (e.g. from other computing devices), data from external devices (e.g., weight scales, environmental sensors, etc.), among other data. The input may be continual, intermittent, and/or scheduled. The communications module 94 may, in one embodiment, provide electronic messages comprising a set coaching style and/or content and other information such as activity monitoring data and/or other dashboard data, via I/O interfaces 80 to the wearable device 12 and/or the electronics device 14. In some embodiments, the communications module 94 may comprise a web service component or cloud component which is accessed by a client application (e.g., browser) residing at the wearable device 12 and/or electronics device 14. Functionality of the message processing engine 90 is described below in conjunction with FIG. 5.

Execution of the application software 30B (including the message processing engine 90 and associated software modules 92-94) may be implemented by the processor 78 under the management and/or control of the operating system. The processor 78 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the computing device 74.

The I/O interfaces 80 comprise hardware and/or software to provide one or more interfaces to the Internet 18, as well as to other devices such as a user interface (UI) (e.g., keyboard, mouse, microphone, display screen, etc.) and/or the data structures 86-88. The user interfaces may include a keyboard, mouse, microphone, immersive head set, display screen, etc., which enable input and/or output by an administrator or other user. The I/O interfaces 80 may comprise any number of interfaces for the input and output of signals (e.g., analog or digital data) for conveyance of information (e.g., data) over various networks and according to various protocols and/or standards. The user interface (UI) is configured to provide an interface between an administrator or content author and the computing device 74. The administrator may input a request via the user interface, for instance, to manage the user profile data structures 86 and/or the coaching messages data structures 88. Updates to the data structures 86 and/or 88 may also be achieved without administrator intervention.

When certain embodiments of the computing device 74 are implemented at least in part with software (including firmware), as depicted in FIG. 4, it should be noted that the software (e.g., including the application software 30B (and associated modules 90-94) can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the computing device 74 are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), relays, contactors, etc.

Referring now to FIG. 5, shown is a flow diagram that illustrates an example process 96 implemented by a rapport building virtual assistant system, in accordance with an embodiment of the invention. The process 96 may be implemented using a single device (e.g., the wearable device 12, electronics device 14, or the computing device 74), or in some embodiments, according to any combination of these devices. It should be appreciated by one having ordinary skill in the art in the context of the present disclosure that variations to the process 96 may be implemented in some embodiments, including the addition of steps in the process and/or omission of some steps. Referring to (98), at program start, after a determination of insufficient confidence in a determined style/content from a result towards the end of the process 96, at a specific (e.g., scheduled) time, or in response to an event or behavior related to a target behavior in a program (e.g., a fitness monitoring program, such as just after completing a run the user feels great about it and is prompted to compose a message for a sports activity for a peer, friend, etc.), the rapport building virtual assistant system can ask the client to write (and/or record) a specific motivational messages for a friend or relative or another user. As indicated above, some embodiments of the rapport building virtual assistant system may, in addition to, or in lieu of the specific request to the user to compose a message, harvest composed messages of the user from other resources. As an example of actively soliciting the user to compose the message, the rapport building virtual assistant system may present the user with a template comprising an example scenario that includes a description of the status, issue and/or target behavior of another person, and ask the user (writer) to write a specific motivational message in an open text field, to be delivered to that other user implicated in the scenario. This other user can be a real person or a virtual person.

With continued reference to FIG. 5, attention is drawn to FIGS. 6A-6B, which provide illustrative examples of graphical user interfaces (GUIs) 100 (e.g., 100A in FIG. 6A, 100B in FIG. 6B) that provide two examples of potential open text questions to be presented to, and answered by, the user (writer). As set forth above, the GUIs 100 may be presented by the wearable device 12 and/or the electronics device 14, and may be internally generated or received as web pages from the computing system 20 (FIG. 1). The GUIs 100 each comprise a template having a prompt section 102 and text box section 104. The prompt section 102 comprises a scenario that is intended to prompt a motivational message to be entered by the user in the text box section 104 that can be analyzed to determine the coaching style and/or content compatible with the friend, family member, etc. As explained above, since rapport is established between people that get along with each other, the motivational message composed in the text box section 104 by the user should be of a coaching style and/or content that the user would wish to experience himself. Concerning the selection of the person that should be targeted by the user when composing a motivational message, the rapport building virtual assistant system can specifically ask the user (e.g., in the prompt section 102) to generate messages for someone like him or her. This can be done in an explicit way by offering a list of friends or profile descriptions, and asking the user to select the person which looks/acts/behaves most like himself/herself. Alternatively, the request can also be done in an implicit way by providing a description of a pre-selected third person which has the most similarities with the user, as derived from a behavior of the user and/or characteristics/traits already known by the rapport building virtual assistant system.

In the example of FIG. 6A, the scenario presented in the prompt section 102 comprises the following description: “Suppose your friend John (in week 6 of weight loss program) has not used his weight scale for 2 weeks. Please write down below a message of max. 500 characters to motivate him to use his scale more frequently.” Note that the scenario presented (or the limitation of 500 characters) is merely illustrative and other scenarios or character count may be imposed. In the text box section 104, the user enters (e.g., types in) a motivational message that responds to the scenario presented in the prompt section 102, and then selects the submit button icon 106 to store the composed message. In the example presented in FIG. 6B, the scenario presented in the prompt section 102 comprises the following description: “We just noticed that your father George (in week 8 of GetFit Program) has doubled his step count per week since the start. Please write down below a message of max. 500 characters to send him a compliment on his progress.” The user responsively enters a motivational message in the text box section 104 that responds to the scenario, and selects the submit button icon 106.

Note that in some embodiments, instead of, or in addition to, the text message entered in the text box 104, the user may be asked to record a voice message or video message to motivate a friend or another person. In this case, the text and/or voice and/or visual characteristics can be used to derive a coaching style. Examples of voice characteristics are intonation, rhythm, pitch, volume, etc., and examples of visual characteristics are facial expression, pupil dilation, body posture, etc.

Referring again to FIG. 5, the rapport building virtual assistant system then receives the composed message entered in the GUIs 100 (108). In one embodiment, the message is composed at the electronics device 14 (FIG. 1), and communicated to the computing device 74 (FIG. 4). In some embodiments, the composed message is harvested from other resources. As noted above, the received message may be in the form of text, video, and/or audio. The received message may be stored in the user profile data structure 86 (FIG. 4) located in coupled storage (e.g., in a storage device, including memory 82 (FIG. 4)). In some embodiments, additional information (e.g., context) may be received. For instance, the electronics device 14, using clock functionality of the device 14, may record the amount of time used to compose the messages (e.g., speed of typing), and the clock time at which the messages had been created and/or submitted. Such additional information may be used to identify moments when the user has the apparent time to write the motivational message and/or to identify opportune moments to deliver the electronic messages. Other context information that may received includes emotional state and/or in general, psychological state.

In (110), the rapport building virtual assistant system analyzes the composed message and determines a coaching style and/or content. As explained above, the processing (analysis) may be performed at the wearable device 12, the electronics device 14, or the computing device 74. Continuing with the example of FIG. 5, it is assumed the processing is performed at the computing device 74 (e.g., by the message processing engine 90, FIG. 4). In one embodiment, the rapport building virtual assistant system performs semantic and syntactic analysis of the messages to detect the user-specific coaching style and/or content from those messages (e.g., detect for use of a lot of encouragement, positivity, strict/firm tone, etc.). In some embodiments, the composed message may be in video and/or audio form (in addition to or in lieu of text form), where the rapport building virtual assistant system may analyze for voice characteristics (e.g., intonation, rhythm, pitch, volume, etc.) and/or visual characteristics (e.g., facial expression, body posture, pupil dilation, etc.). The analysis performed in (110) includes the detection of features of style of writing. Table 1, below, illustrates some example features for style of writing, including some examples of the feature and an example mechanism of detection used by an embodiment of a rapport building virtual assistant system.

TABLE 1

| Feature | Example | Detection |
|---|---|---|
| Formality | Words that match formal | Bag of words |
| | address (e.g. please or | approach/supervised |
| | would/could/dear/with | learning |
| | regard to/would | |
| | like/appreciate) | |
| Familiarity | slang, figures of speech, | Bag of words |
| | broken syntax, | approach/supervised |
| | abbreviations | learning. Alternatively: |
| | | semi supervised learning, |
| | | see note2 |
| Persuasion | General persuasive | Bag of words |
| | reasoning or specifically | approach/supervised |
| | authority, scarcity, social | learning, see note3 |
| | proof, liking, commitment, | |
| | reciprocity (see note1) | |
| Facts | Relating to objectively true | Numbers, percentages, |
| | information about the | source/references |
| | behavior (e.g. ‘Taking one | |
| | flight of stairs burns on | |
| | average 15 calories.’) | |
| Emotion | Positive or negative words, | Use of emoticons. |
| | such as ‘dislike, hate, | Bag of words |
| | stupid’ and ‘beautiful, | approach/supervised |
| | perfect, glad’ | learning of |
| | | positive/negative words. |
| Positive or | Encouragement or | Bag of words |
| negative | punishment | approach/supervised |
| feedback on | | learning. |
| behavior | | |
| Intensity level | Exclamation marks, | Bag of words, punctuation |
| | superlatives | analysis |

Table 1 identifies some example features for style and examples of how they can be detected by such technical solutions. Note that the list of features in Table 1 is not exhaustive, and that additional or other features may be identified (e.g., tone of voice). For instance, descriptors may be developed over time for use in profiles (described below), or which features correspond to which profiles may be automatically learned (e.g., by the system), or learned by humans, over time. Many of the detection approaches rely on a ‘bag of words’ or ‘corpus’, which is the basis for a form of supervised learning where there is a direct matching of words/parts of written text with a list of words that are categorized according to the features (e.g., words that are categorized as having a negative sentiment or having a formal character). Variations of these detection approaches may be used, including the use of unsupervised learning to learn specific phrasings and/or the order of phrasings for a specific user. The notes (1-3) are referenced to find additional information on the examples and/or detection approach. Further information for Note1 may be found in Cialdini, R. B. (1993), “Influence: The psychology of persuasion.” New York: Morrow. Further information for Note2 may be found in Pal, A. R., & Saha, D. (2013), “Detection of Slang Words in e-Data using semi-Supervised Learning. International Journal of Artificial Intelligence & Applications, 4(5), 49. Further information for Note3 may be found in Young, J., Martell, C. H., Anand, P., Ortiz, P., & Gilbert IV, H. T. (2011, August). A Mirotext Corpus for Persuasion Detection in Dialog. “In Analyzing Microtext.”

The message as entered by the user is analyzed for different features, including the features shown in Table 1. Those features are used when a new (subsequent) coaching message for the client is generated. There are many known technological solutions that can be applied by an embodiment of a rapport building virtual assistant system to detect those features (e.g. open source packages such as LibShortText, NLTK or Pattern can be used to do natural language processing and sentiment analysis). In some embodiments, analysis of other information may include the amount of time to create the message and/or the clock time which the message had been created and/or submitted, among other context information including location, body measures, etc.

The rapport building virtual assistant system may, in lieu of or in addition to style detection, analyze the message for content. For instance, the rapport building virtual assistant system may identify the content as having a communicative objective, or an objective of education or instruction. The rapport building virtual assistant system may use similar detection methods as performed for style detection, including a bag of words/corpus approach that detects what behavioral determinant the content addresses (e.g., the content is written to increase one or more behavioral determinants). Examples of behavioral determinants include motivation, attitude, barriers, and self-efficacy. Note that this list is not exhaustive, and other and/or additional behavioral determinants may be used, including coping style, social norms, social support, comping strategies, skills, and locus of control. As some examples of a content only analysis, the rapport building virtual assistant system, while implementing a textual analysis, detects numbers in combination with a reference to a source, the rapport building virtual assistant system may label the message as educational, or if quotes and/or paraphrases are detected, the system may label the message as inspirational. Considering vide/audio analysis, the rapport building virtual assistant system may transcribe (using natural language understanding) the audio signal, enabling a textual analysis (e.g., using a bag of words/corpus approach or phrases/sentences, such as attributing “you can do this” to something meaningful as opposed to each of the words standing alone).

In one embodiment, the rapport building virtual assistant system determines a style and/or content by creating a score based on the amount of detected features. The rapport building virtual system may use different profiles or profiles, which are made up of the above-described different features. In one embodiment, the profiles are combinations of style and content preferences, with more emphasis on style in some embodiments. In some embodiments, there may be separate content profiles and style profiles, which may be combined in multiple different combinations. In any case all messages are tagged with a style and content type. For instance, the rapport building virtual assistant system may configure a sensitive profile (e.g., a predefined profile, though profiles may change or profiles added to over time using automatic learning algorithms or via administrator configuration) that includes the following features (which may be further sub-divided between required and optional features for a profile): emotions, submissive, cautious, need for cognition. It is noted that these features comprise a mix of behavioral determinants (e.g., emotions, need for cognition), which relate to the determinants in Table 1 above, and personality. In some embodiments, such profiles may be identified from published literature (e.g., BIG-5, BIG4PAMS). These features may be detected using the tools from Table 1, such as sentiment analysis or word detection. The rapport building virtual assistant system (e.g., the message processing engine 90, FIG. 4) ranks all of the different profiles according to how many features were detected. The one with the highest score may be selected and used as a basis for the generation of future (new) generated messages.

Continuing with the process 96 depicted in FIG. 5, the rapport building virtual assistant system (e.g., message processing engine 90, FIG. 4) determines whether there is enough confidence in the determined style and/or content by comparing to a threshold (114). That is, a threshold can be used that, if the score of the profiles is not above a certain threshold, this means that the rapport building virtual assistant system has not been able to detect enough features to confidently assign the user to that profile. This threshold can be determined by learning from the user response, or by human classification. Based on a determination that the confidence is below the threshold (“No” in FIG. 5), the user is prompted again (98) to respond (e.g., compose one or more additional motivational messages) based on one or more scenarios (as illustrated similarly in FIGS. 6A-6B).

Based on a determination that the confidence is above the threshold (“Yes” in FIG. 5), the rapport building virtual assistant system (e.g., message processing engine 90, FIG. 4) sets the coaching style and/or content for that particular user in accordance with the best matching profile (116). In one embodiment, the rapport building virtual system selects messages from a large database of coaching messages (clustered per style and/or content) that fit the user-specific style and/or content and completes a corresponding message template. For instance, upon selection of a given message with the best matching profile, the message processing engine 90 fills in blanks (e.g., variables, fields) with personalized data, including the user's (receiving the message) performance and/or profile information, including name, goal, number of times a goal is reached, etc. The message templates may be predefined (e.g., by an administrator) and further configured based on machine or human learning. The message selected is most likely the message having a style and/or content that has an optimal impact on building rapport with the virtual assistant. Note that in some embodiments, a template may be omitted, where entirely predefined messages are used. In one embodiment, the rapport building virtual assistant system performs a comparison between the features from the determined style and/or content from the analysis (110) of the motivational message and coaching messages of the coaching message data structure 88 (FIG. 4) and sets the style and/or content for association with the user based on a match or closest match from the comparison.

Based on the match, the rapport building virtual assistant system coaches the user by sending him/her electronic messages comprising motivational (coaching) messages that have a similar style and/or content to the motivational messages composed by the user. In one embodiment, the computing device 74, based on data extracted from the performance monitoring module 92 as part of the application software 30B (e.g., executing as a fitness activity program), communicates the tailored electronic messages (e.g., according to the set coaching style and/or content) via the communications module 94 to the electronics device 14 (and/or wearable device 12) for presentation of the motivational messages. These messages may be triggered during activity. For instance, one or more messages may be delivered by the communications module 94 to the devices 12 and/or 14 beforehand and stored locally until an appropriate time arises to present the message(s). In some embodiments, messages are sent directly (in real time when intended for presentation) from the communications module 94. In some embodiments, the manner of delivery (e.g., Whatsapp, email, smart watch, etc.) is according to the settings established by the user (and stored in the user profile data structure 86, FIG. 4).

Note that variations to the above-described process 96 may be used in some embodiments, and hence are contemplated to be within the scope of the disclosure. In one embodiment, the rapport building virtual assistant system can vary the type of messages that are provided to the user to learn which type of coaching style/content is best received by the user. For instance, the rapport building virtual assistant system starts with mostly coaching messages that have similar features (e.g., as shown in Table 1) as those messages that were composed by the user, and also include a small portion of coaching messages with different features. By asking the user to rate each coaching message (e.g., directly after receiving the message), the rapport building virtual assistant system can gradually learn which coaching messages are most appreciated by the user and start providing more coaching messages that have features similar to the highly rated messages. In this embodiment, the rapport building virtual assistant system only relies on the principle of rapport building in the beginning and would gradually adapt the messages over time based on a smart reasoning technique that derives which message features are most appreciated. In a similar manner, the adaptation of types of messages that are selected for the user can be based on how impactful they are on the behavior of the user, rather than on the subjective rating of the user. For instance, the rapport building virtual assistant system may make this assessment based on input from biophysical sensors, activity data, GPS data, app use, and/or any input that helps to establish behavioral patterns. In general, these embodiments that vary the type of coaching message provide messaging based on the original analysis of the style and/or content of the message composed by the user, yet since there is not a 100% match, the rapport building virtual assistant system includes slight variations to determine from real-time input (e.g., by the user or as monitored) the preferred style and/or content.

In some embodiments, the rapport building virtual assistant system may implement a coaching program that consists of both human-to-human coaching and automated coaching (referred to as a hybrid coaching program). In this embodiment, a user can receive motivational messages both from a professional or friend or family member, and from an automated coach. In this case, the rapport building virtual assistant system analyzes the style and/or content of the motivational messages, received by the user, from the professional or friend or family member. The automated (e.g., coaching) messages with a similar style and/or content can then be selected from the database to be applicable for this user. Optionally, in such a hybrid coaching program as described above, the rapport building virtual assistant system can monitor the impact of coaching messages from a human coach on user behavior in a period after the coaching message is delivered, and the style of automated coach messages can be adapted to the specific style and/or content approach used in the more effective messages from the human coach. In other words, the rapport building virtual assistant system keeps track of the impact of the coaching messages in relation to the type of style and/or content and based on the impact, the style and/or content of the most effective messages (e.g., those with the greatest or desirable impact on behavior) serve as the basis on which future messages are adapted. In these hybrid coaching programs, the user can not only receive messages from a human coach or another user, but he can also send messages to these people. Optionally, the system detects the style and/or content of these messages by analysis in the background without explicitly asking the user to write motivational messages at a specific moment for a specific person.

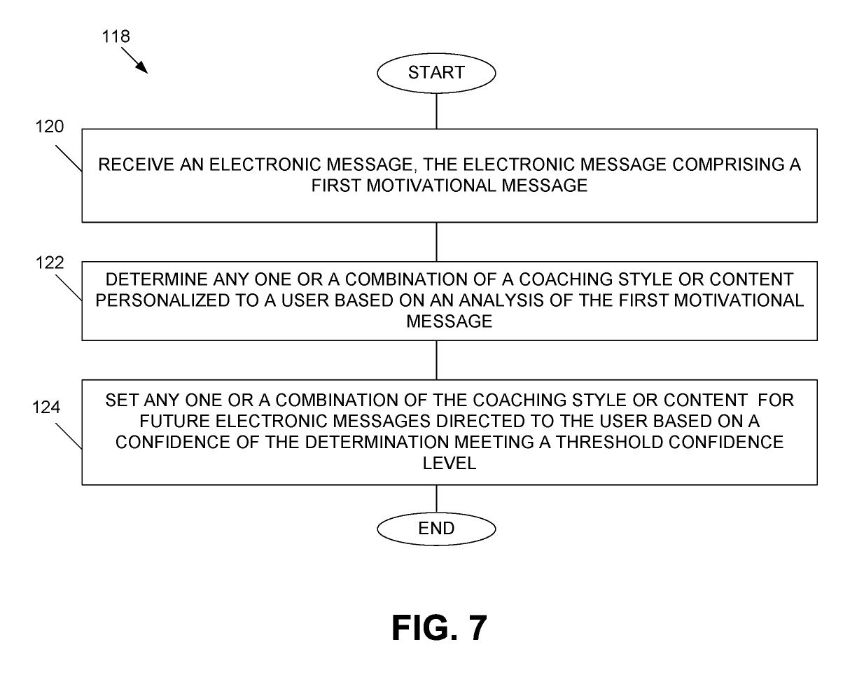

In view of the description above, it should be appreciated that one embodiment of a computer-implemented, rapport building virtual assistant method, depicted in FIG. 7 and referred to as a method 118 and encompassed between start and end designations, comprises receiving an electronic message, the electronic message comprising a first motivational message (120); determining any one or a combination of a coaching style or content personalized to a user based on an analysis of the first motivational message (122); and setting any one or a combination of the coaching style or content for future electronic messages directed to the user based on a confidence of the determination meeting a threshold confidence level (124).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

Though various embodiments of a rapport building virtual assistant system have been disclosed in the context of coaching in a fitness regime or program (e.g., health and wellness), it should be appreciated by one having ordinary skill in the art that applications for the rapport building virtual assistant system may be extended to other fields. For instance, in the financial industry, the rapport building virtual assistant system may enable a user to enter a message involving support with respect to investments or savings (e.g., as part of an investment app). Messages composed by the user may vary depending on various demographics, including gender. For instance, analysis of the messages created by a man may find that features pertaining to competition (e.g., short-term performance, such as stock results compared to index, etc.) are more desirable, whereas messages from a woman may be oriented more toward long-term or life milestones (e.g., care for children, parents, etc.). Thus, in addition to tonal differences in future message, the differences in content among genders (or other demographics) may be captured more suitably (and provide more persuasive or impactful effect) using the messaging of a rapport building virtual assistant system, particularly as virtual-assisted investing becomes more popular.

As a further example of variations to the above-description of certain embodiments of a rapport building virtual assistant system, though textual feedback (presentation of the messaging) has been described as via the wearable device 12 and/or electronics device 14, feedback messaging may be presented audibly (in lieu of, or in addition to text) via speaker functionality of either device 12, 14 (FIG. 1) and/or visibly (e.g., video playback of an avatar). In some embodiments, the messaging may be conveyed via a third party. For instance, the messages of a set coaching style and/or content may be delivered to a third person (e.g., the user's coach or trainer or mentor), and in turn conveyed verbatim or substantially verbatim by the third person. The message may be delivered, for instance, to an earpiece worn by the third person and relayed by the third person to the user.

Note that various combinations of the disclosed embodiments may be used, and hence reference to an embodiment or one embodiment is not meant to exclude features from that embodiment from use with features from other embodiments. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical medium or solid-state medium supplied together with or as part of other hardware, but may also be distributed in other forms. Any reference signs in the claims should be not construed as limiting the scope.

At least the following is claimed:

1. A system, comprising:
a memory comprising executable code; and
one or more processors configured by the executable code to:
receive an electronic message, the electronic message comprising a first motivational message;
determine any one or a combination of a coaching style or content personalized to a user based on an analysis of the first motivational message; and
set any one or a combination of the coaching style or content for future electronic messages intended for the user based on a confidence of the determination meeting a threshold confidence level.

2. The system of claim 1, wherein the one or more processors are configured by the executable code to receive the electronic message based on any one or combination of harvesting the first motivational messages composed by the from electronic resources or prompting the user to generate the first motivational message, wherein the one or more processors are configured by the executable code to prompt the user by instructing the user to generate the first motivational message for a targeted audience of a friend, a relative, or another user having similar traits to the user.

3. The system of claim 2, wherein the one or more processors are configured by the executable code to receive the electronic message based on prompting the user to generate the first motivational message, wherein the one or more processors are configured by the executable code to prompt the user by:
presenting to the user one or more example scenarios for the friend, the relative, or the other user that are designed to enable the one or more processors to derive the coaching style; and
enabling the user to generate the first motivational message based on the one or more scenarios.

4. The system of claim 3, wherein the one or more processors are configured by the executable code to:
enable the user to generate the first motivational message by providing any one or a combination of open text field for input by the user, record an audio message spoken by the user, record a video message of the user; and
determine by analyzing any one or a combination of an amount of time to create the first motivational message, an absolute time as to when the first motivational message was either created or submitted, voice characteristics of the audio message, or video characteristics of the video message.

5. The system of claim 1, wherein the received electronic message comprises any one or a combination of a video, an audio, or a text, wherein the text includes emoticons.

6. The system of claim 1, wherein the one or more processors are configured by the executable code to determine a coaching style by:
detecting coaching style features in the first motivational message; and
comparing the detected coaching style features with a data structure comprising coaching style features to determine a match, wherein, based on the match, the one or more processors are configured to set the coaching style.

7. The system of claim 6, wherein the coaching style features comprise any one or a combination of at least formality, familiarity, persuasion style, facts, emotion, positive or negative feedback of behavior, tone of voice, or intensity level.

8. The system of claim 6, wherein the one or more processors are configured by the executable code to match using any one or a combination of at least word matching, supervised learning, semi-supervised learning, unsupervised learning, punctuation analysis, analysis relating to objective data, or use of emoticons.

9. The system of claim 6, wherein the one or more processors are further configured by the executable code to provide a coaching message comprising a second motivational message to the user based on the coaching style setting, wherein the second motivational message comprises one or more of the matched coaching style features.

10. The system of claim 9, wherein the data structure comprises a fixed, dynamic, or template-based data structure, wherein the data structure further comprises a plurality of coaching messages clustered or tagged according to a plurality of coaching style features, wherein the one or more processors are configured by the executable code to provide the second motivational message by selecting one of the plurality of coaching messages with the coaching style features that match the coaching style features from the first motivational message.

11. The system of claim 9, wherein the one or more processors are configured to enable the user to select a manner of delivery of the second motivational message or learn the manner of delivery for the second motivational message.

12. The system of claim 1, wherein the one or more processors are configured by the executable code to determine the content by matching, using any one or a combination of at least word matching, supervised learning, semi-supervised learning, unsupervised learning, punctuation analysis, analysis relating to objective data, or use of emoticons, content features from the first motivational message from a data structure of content features.

13. The system of claim 12, wherein the content features comprise at least behavioral determinants, wherein the content features comprise any one or a combination of at least motivation, attitude, barriers, or self-efficacy.

14. The system of claim 12, wherein the one or more processors are further configured by the executable code to provide a coaching message comprising a second motivational message to the user based on the content, wherein the second motivational message comprises one or more of the matched content features, and wherein the one or more processors are configured to enable the user to select a manner of delivery of the second motivational message or learn the manner of delivery.

15. The system of claim 1, wherein the one or more processors are further configured by the executable code to provide coaching messages comprising one or more second motivational messages to the user based on the set coaching style and content.

16. The system of claim 1, wherein the one or more processors are further configured by the executable code to:
provide one or more coaching messages to the user based on the one or combination of the set coaching style or content, and further based on a variation of coaching messages;
receive a ranking by the user of the one or more coaching messages; and
adapting the coaching messages provided in the future based on the rankings.

17. The system of claim 1, wherein the one or more processors are further configured by the executable code to receive the electronic message from one of a friend, a professional, a family member, or an automated virtual assistant.

18. The system of claim 1, wherein the one or more processors are further configured by the executable code to provide electronic messages in the future based on receiving an indication of an impact on behavior resulting from respective prior electronic messages based on the settings of any one or combination of the coaching style or content and a manner of delivery, and adapting the future electronic messages based on a subset of the any one or combination of the coaching style or content for which the impact on behavior is most desirable.

19. A computer readable medium encoded with instructions that, when executed by one or more processors, causes the one or more processors to:
receive an electronic message, the electronic message comprising a first motivational message;
determine any one or a combination of a coaching style or content personalized to a user based on an analysis of the first motivational message; and
set any one or a combination of the coaching style or content for future electronic messages directed to the user based on a confidence of the determination meeting a threshold confidence level.

20. A computer-implemented method, comprising:
receiving an electronic message, the electronic message comprising a first motivational message;
determining any one or a combination of a coaching style or content personalized to a user based on an analysis of the first motivational message; and
setting any one or a combination of the coaching style or content for future electronic messages directed to the user based on a confidence of the determination meeting a threshold confidence level.
